(19) United States
(12) Patent Application Publication
(10) Pub. No.: US 2003/0135451 A1
(43) Pub. Date: Jul. 17, 2003

(54) Loan allocation according to lending frequency based preference

(75) Inventors: Michael P. O'Brien, Mission Viejo, CA (US); Donald D. Bundy, Mission Viejo, CA (US)

Correspondence Address: MCDERMOTT, WILL & EMERY, 2049 Century Park East, Suite 3400, Los Angeles, CA, 90067, US

(73) Assignee: Gresham Financial Services, Inc.

(21) Appl. No.: 10/217,633

(22) Filed: Aug. 13, 2002

Related U.S. Application Data
(60) Provisional application No. 60/312,024, filed on Aug. 13, 2001.

(51) Int. Cl. G06F 17/60

(52) U.S. Cl. 705/38

(57) ABSTRACT

Computerized systems and methods for simultaneously managing multiple securitization pools are disclosed. The simultaneous management methods allow lenders to re-allocate loans into secondary loan pools when the loans become ineligible for primary loan pools. Lenders are thereby saved from having to carry loans on their books when they become ineligible for a primary loan pool. The methods also allow lenders to allocate a loan to relatively higher valued loan securitization pools based on loan characteristics, and to re-allocate the loan to a relatively lower valued loan securitization pool should the loan fall out of or become disqualified from the relatively higher valued loan securitization pool. The disclosed systems and methods provide smaller lenders with the ability place their loans in the most beneficial loan securitization pool available. Smaller lenders therefore can both contribute to larger multi-lender loan portfolios that would otherwise be unattainable to the individual lenders, and select from among a plurality of loan securitization pools such that the lender can ensure the highest possible value for the loan when it is ultimately converted.

### CROSS REFERENCE TO RELATED APPLICATION

This application is related to and claims the benefit of the filing date of U.S. provisional application Serial No. 60/312,024, filed Aug. 13, 2001, entitled “Method and Apparatus for Electronic Loan Creation, Processing, Settlement, Fulfillment and Syndication,” the contents of which are incorporated herein by reference.

### BACKGROUND OF THE INVENTION

1. Field of the Invention

The invention relates primarily to loan securitization and management. More specifically, the invention relates to systems and methods for initiating, creating, managing, and securitizing loans and other credit programs.

2. General Background and State of the Art

Banks and other lenders who carry loan balances on their books benefit from converting their loan portfolios to cash, which can then be used to make additional loans. One way that lenders can convert their loans into cash is by selling their loan portfolios. Lenders tend to pool their loans into portfolios that can be sold, such as to a bond trader or investment banker, and converted to cash.

Several problems can arise in connection with this commonly practiced approach. First, many lenders are unable to take such an approach, and are therefore unable to convert their loans to cash. This is because a loan portfolio typically cannot be sold to a bond trader until it reaches a certain minimum level. Currently, this level is often around $100 million for maximum profitability. Such a high amount makes practicing this loan conversion approach cost prohibitive for smaller lenders, who simply do not have portfolios of that size.

Another common problem is that smaller lenders do not generate enough loans to establish multiple loan portfolios. This problem also forces lenders to restrict the variety of loans that they offer so that the volume of loans for similar products is greater. This consolidation of loan types increases the risk to the lender because the loan portfolio is not sufficiently diversified. The separation of a lender's loans would be desirable because bond traders apply different values to loan portfolios according to the characteristics of the portfolios. For example, loan portfolios including revolving credit loans may be less valuable than loan portfolios including installment plan loans. Other characteristics according to which value is measured include, but are not limited to, loan terms, interest rate, and classification of securitization, such as auto or home. However, because of the inability of smaller lenders to generate enough loans to have multiple loan portfolios, these smaller lenders are often unable to take advantage of loan conversion.

A further common problem is that there is not currently an efficient method for optimizing loan such that their value to bond traders is maximized. There is also not currently a method for efficiently matching a lender's loan portfolio with an interested bond trader. Typically, when a portfolio reaches the minimum amount, such as $100 million, the lender must individually “shop” the portfolio in order to convert it to cash. This is often accomplished by hiring an investment banker to find a buyer on Wall Street. This manual process is highly individualized, highly subjective, and produces uncertain and inefficient results. Moreover, these loan portfolios, which were not established to have optimized loan characteristics, are difficult to analyze and assign a value to. The result is that such loan portfolios are often heavily discounted by bond traders or other potential purchasers.

Yet another common problem is that lenders are typically required to make a guarantee to the buyer that the loans within the portfolio will be paid back. These guarantees must be carried on the books of the lenders, which creates an offset against any value the lender received by converting the portfolio. Moreover, because of FDIC and federal auditing rules, loan guarantees made by the lenders require the lenders to carry a greater cash reserve, again offsetting the cash value attained by converting the portfolio.

### INVENTION SUMMARY

The present invention helps solve the above problems and others by providing to computerized methods and systems for initiating, creating, managing, and securitizing loans and other credit programs electronically. One embodiment of the invention allows lenders to participate in loan securitization pools with other lenders, such that they can collectively establish a pool amount that is large enough to sell and convert to cash. Another embodiment of the invention also allows lenders to allocate a loan to relatively higher valued loan securitization pools based on the loan characteristics, and to re-allocate the loan to a relatively lower valued loan securitization pool should the loan fall out of or become disqualified from the relatively higher valued loan securitization pool during its seasoning period, before it has matured. This ability for smaller lenders to participate in loan securitization pools and to re-allocate loans during their seasoning period means that the loans may always be placed in the most beneficial loan securitization pool available. This flexibility allows lenders to both contribute to larger multi-lender loan portfolios that would otherwise be unattainable to the individual lenders, to select from among a plurality of loan securitization pools such that the lender can ensure the highest possible value for the loan when it is ultimately converted and to accept a broader spectrum of loans into a portfolio because there is a pool which will accept the loan product.

Another embodiment of the invention comprises a method for simultaneously managing multiple securitization pools. The simultaneous management method of this embodiment allows lenders to re-allocate loans into secondary loan pools when the loans become ineligible for primary loan pools. This method saves lenders from having to carry loans on their books when they become ineligible for a primary loan pool.

In one embodiment of the invention, a loan in a first loan pool that becomes ineligible for the first loan pool is re-allocated to a second loan pool for which it is eligible. After the loan becomes ineligible for the first loan pool, a second loan pool subscribed to by the lender and for which the loan is eligible is identified. The loan is then reallocated into the identified second loan pool.

In another embodiment of the invention, loan features for a loan are entered into a computerized system, a storage system is queried to determine loan eligibility requirement factors for a plurality of loan securitization pools, a first loan securitization pool is identified for which the loan is qualified based on the entered loan features and on the determined loan eligibility requirement factors for the first loan securitization pool, the loan is allocated to the first loan securitization pool, and a second loan securitization pool is identified for which the loan is qualified based on the loan features and on loan eligibility requirement factors for the second loan securitization pool.

In yet another embodiment of the invention, multiple loan securitization pools are managed by allocating a loan to a first loan securitization pool for which it is qualified based on an initial set of loan features and on loan eligibility requirement factors for the first loan securitization pool, a second set of loan features is determined if the loan becomes disqualified from the first loan securitization pool, a second loan securitization pool is identified for which the loan is qualified based on the second set of loan features and on loan eligibility requirement factors for the second loan securitization pool, and the loan is re-allocated to the second loan securitization pool.

In a further embodiment of the invention, a system for managing multiple loan securitization pools comprises an input device for entering loan features for a loan into a computerized system, a storage system for storing the entered loan features, a processor for determining loan eligibility requirement factors for a plurality of loan securitization pools, identifying from the plurality of loan securitization pools a first loan securitization pool for which the loan is qualified based on the entered loan features and on loan eligibility requirement factors for the first loan securitization pool, allocating the loan to the first loan securitization pool, and identifying a second loan securitization pool for which the loan is qualified.

In yet a further embodiment of the invention, a system for managing multiple loan securitization pools comprises a processor for allocating a loan having a first set of loan features to a first loan securitization pool for which it is qualified and determining a second set of loan features if the loan becomes disqualified from the first loan securitization pool, a storage system for storing information about a plurality of loan securitization pools, and the processor also querying the storage system to determine loan eligibility requirement factors for a plurality of loan securitization pools and identifying a second loan securitization pool for which the loan is qualified and re-allocating the loan to the second loan securitization pool.

In yet another embodiment of the invention, computer-readable media containing instructions executable by a computer cause the computer to receive loan features for a loan, query a storage system to determine loan eligibility requirement factors for a plurality of loan securitization pools, identify a first loan securitization pool for which the loan is qualified based on the received loan features and on loan eligibility requirement factors for the first loan securitization pool, allocate the loan to the first loan securitization pool, and identify a second loan securitization pool for which the loan is also qualified.

In yet another embodiment of the invention, computer-readable media containing instructions executable by a computer cause the computer to allocate a loan to a first loan securitization pool for which it is qualified based on an initial set of loan features and on loan eligibility requirement factors for the first loan securitization pool, determine a second set of loan features if the loan becomes disqualified from the first loan securitization pool, query a storage system to identify a second loan securitization pool for which the loan is qualified based on the second set of loan features an on loan eligibility requirement factors for the second loan securitization pool, and re-allocate the loan to the second loan securitization pool.

The foregoing and other objects, features, and advantages of the present invention will become apparent from a reading of the following detailed description of exemplary embodiments thereof, in conjunction with the accompanying drawing Figures.

### BRIEF DESCRIPTION OF THE DRAWINGS

FIG. 1 illustrates a layered structure for loan eligibility requirements used by an exemplary embodiment of the invention.

FIG. 2 illustrates a network relationship between credit applicants, merchants, lenders, credit bureaus and other entities involved in various exemplary embodiments of the invention.

FIG. 3 illustrates a first exemplary computer input screen for receiving information from a credit application into a computerized system in an embodiment of the invention.

FIG. 4 illustrates a second exemplary computer input screen for receiving information from a credit application into a computerized system in an embodiment of the invention.

FIG. 5 illustrates an exemplary digital signature enrollment process that may be utilized with embodiments of the invention.

FIG. 6 illustrates an exemplary computer information screen indicating to a credit applicant that a credit application is being processed in an embodiment of the invention.

FIG. 7 illustrates a communication system diagram describing communications relationships between lenders, merchants, applicants and other entities involved in embodiments of the invention.

FIG. 8 illustrates an exemplary computer information screen informing a credit applicant that a credit application has been approved according to systems and methods of the invention.

FIG. 9 illustrates an exemplary computer information and input screen informing an approved credit applicant of loan terms and requesting agreement information from the loan applicant.

FIG. 10 illustrates an exemplary computer information screen informing a credit applicant that a credit application was denied during automatic credit review processes in an embodiment of the invention, and will undergo further review according to manual credit review processes of the invention.

FIG. 11 illustrates an exemplary computer information screen informing a credit applicant that a credit application was denied under both automatic and manual credit review processes in an embodiment of the invention.

FIGS. 12-17 illustrate an exemplary embodiment of the invention as applied in an online merchant environment.

### DETAILED DESCRIPTION OF THE PREFERRED EMBODIMENTS

It is to be understood that the term “loan,” as used herein, refers to any form of credit including but not limited to leasing, commercial credit lines, commercial flooring, installment loans, revolving credit, and credit cards. Also, rule books are computer programs that analyze data and make programmed decisions based upon that data. The rule books typically enforce business process rules, for example. Finally, a loan securitization pool is an accumulation of loans that meet a common set of standards, and that can be securitized with an investment bank once it reaches a certain, pre-defined value. The standards that must be met in order for a loan to qualify for allocation to a loan securitization pool are referred to herein as “loan eligibility requirements.”

Embodiments of the invention provide a systems and methods for initiating, creating, managing and securitizing loans and other credit programs electronically. The exemplary embodiments provide both a technology and electronic business process controlled by a software program manager that enables the creation of an online loan or credit application. The program manager utilizes online credit decision processes as interpreted by jurisdictional, lender, product financed and merchant coordinated electronic rule books. The program manager utilizes online underwriting and manual intervention of credit application review processes pursuant to coordinated electronic rule books based upon lender, jurisdiction, product financed, merchant and other variables including but not limited to interest free incentive programs, time, volume, risk based credit algorithms and the like. The program manager further utilizes online identity verification technology regulated by jurisdictional, merchant, lender, product, risk based algorithms, and fraud detection rule books.

In addition to the above features, the credit manager plays many additional roles in accordance with the invention. For example, the credit manager provides online contract generation according to jurisdictional, lender product financed and merchant coordinated rule books, and provides online warranty initiation, warranty creation and warranty delivery based upon the same considerations. Also, the credit manager provides electronic loan and credit settlement including but not limited to merchant payment, interest free incentive periods, manufacturer payment, processor payment, customer dispute resolution, credit card issuance and warranty settlement all based upon lender and merchant rule books operated electronically and subject to manual human intervention at critical points. In accordance with the invention, the program manager has functionality to determine what constitutes a critical point where human intervention is required in the loan application review process, as will be more fully explained below. The credit manager also supports online contract signing using digital signatures and electronic signatures, provides electronic contract delivery and storage based upon electronic rule books of lenders, merchants, Certification Authorities and processors, and coordinates electronic loan servicing and management between the lender, merchant and manufacturer with the consumer or loan applicant.

Additional features of the credit manager include electronic payment of individual loans by consumers through an electronic sweeping of consumers' individual bank accounts, debit card or credit card accounts. The credit manager can also create and maintain reserve accounts that are managed and funded electronically, based upon a rule book that determines the amount withheld from each loan or credit offering to fund the reserve account. Additionally, the program manager can electronically maintain a balance in the account based upon the rule book and regulated disbursements from the account after defined minimums have been met.

Still more features of the credit manager include the ability to provide electronic loan consolidation based upon electronic rule books of the lender, merchant and program manager, securitization of consolidated loans based upon electronic rule books, and management of loan securitization pools that have been securitized based upon electronic rule books and are subject to human intervention at critical points.

These various features of the program manager enable the expansion of traditional loan initiation, creation, processing and settlement by using technology to create and manage the loan process for multiple lenders, merchants, and manufacturers using multiple processors and multiple means of communication. In accordance with the invention, each lender may have multiple credit programs, and the multiple processors and means of communication are based upon electronic rule books created and managed by the program manager.

The program manager is configured to electronically consolidate loans according to electronic rule books, such that all loans within a loan securitization pool meet predefined criteria and predefined percentages based upon product mix, size, term, credit risk, dollar amount, merchant, manufacturer, lender, geographic area, interest rate, security and other loan eligibility requirements. The program manager also adheres to pre-established standards for loan creation, credit risk analysis, credit decisioning, contract management, loan settlement procedure, loan conflict resolution, loan servicing, and securitization of loans. Therefore, multiple risks associated with the entire process can be individually characterized so that they can be electronically actuarially evaluated. Such capabilities, provided by systems and methods of the invention, permit the computerized assembly of loans into a bundle loan securitization pool that can be securitized and can be underwritten for identity fraud as well as credit risk.

The business process of systems and methods of the invention are jointly managed by the program manager and a securitization manager. Like the program manager, the securitization manager is a software tool for overseeing and managing the complex interactions of the inventive systems and methods described herein. The securitization manager provides the program manager with defined requirements and standards for the securitization of a loan securitization pool, which can be sold as a security. Methods of the invention provide the program manager with the ability to provide options to lenders to participate in a program that has a defined rate of return that can be backed up by a letter of credit or an insurance policy or bond and a program. The invention also contemplates an option with no such guarantees.

The program manager is then responsible to build and develop those necessary electronic rule books that provide rules and standards by which loans can be made based upon all of the requirements and standards provided by the securitization manager. The rule books are preferably written or constructed in a manner that a computer programmer can provide a computer program that will electronically evaluate the data and enforce rules regarding a loan application, and evaluate whether the loan applicant has met verifiable standards.

The program manager is also configured to build and develop the necessary rules and directives that provide the ability to dynamically evaluate the loan securitization pool during it seasoning stage, and to ensure that all loans within the loan securitization pool continue to meet the loan eligibility requirements. The rules are preferably written in a manner such that a computer programmer can provide a computer program that can electronically evaluate the individual loan, its performance over time and enforce rules regarding the loan.

The program manager is also responsible for building and developing the necessary rules and directives that provide the ability to take non-compliant loans and evaluate them with verifiable standards to determine if such loans can be reassigned to another loan securitization pool by meeting the defined requirements and standards for all existing loan securitization pools in the system. The rules are preferably written in a manner that a computer programmer can provide a computer program that will electronically evaluate the data and enforce rules for allocation to a loan securitization pool.

Various embodiments of the invention employ an initial step of defining the terms and loan eligibility requirements for each loan securitization pool. First, an operator of the securitization manager meets with investment bankers, or other potential purchasers of loan securitization pools, to negotiate with those bankers the loan eligibility requirement for each loan securitization pool. These negotiations result in contracts for loan securitization. In some cases, the contracts will also include terms to service the loan securitization pool after it has been purchased by the investment bank.

At the conclusion of the contracting process, the securitization manager will develop a set of minimum requirements for all loans to participate in the loan securitization pool. These minimum requirements are the loan eligibility requirements. In some cases, the loan eligibility requirements may be developed such that they do not exactly mirror the contract terms; rather, they can be more restrictive to provide a profit margin and/or a margin of risk. The contract with the investment bank may also include warranties for performance that are underwritten by an insurer or another qualified financial institution. The inclusion of such warranties or third party guarantees will directly impact the minimum requirements for the loan securitization pool.

It is possible, within the scope of the invention, to have multiple loan securitization pools with a single investment bank, and multiple loan securitization pools with separate investment banks. All of the loan securitization pools are combined into a loan portfolio, which the securitization manager uses to define the requirements of each loan securitization pool and to develop rules for the program manager. The process is dynamic in that the securitization manager can add new programs at any time to the portfolio, and once an individual loan securitization pool is complete, that particular loan securitization pool will be removed from the list of loan securitization pools available to investment banks for securitization. In accordance with the invention, loan securitization pools become complete when the dollar volume of combined loans has reached a defined level, and when they have enough loans with adequate seasoning to evaluate the performance of the combined loans. Those skilled in the art will be able to readily establish what amount of seasoning is adequate if the amount of seasoning has not been established as an eligibility requirement. Negotiations with investment bankers will establish the defined level for the dollar volume of combined loans at which loan securitization pools are completed.

After the securitization manager has received the loan eligibility requirements, it develops a set of rules for the loan securitization pool which will be provided to the program manager. The program manager uses the rules to develop a computer program that enforces the rules. Specifically, a computer rules analysis program is created to allow the program manager to set rules parameters and to value each rule in relation to all other existing rules. The outcome of this process can be converted into a separate computer program that is designed to enforce the rules.

The computer program for enforcing the rules is preferably a World Wide Web (“web”) interactive program. The web is used as the primary communication medium between all of the participants in the systems and methods of the invention, and the rules that are enforced are therefore converted to a program that can enforce such rules using electronically supplied data via the web. As used herein, the term “web” is used to denote all forms of electronic communication including but not limited to the Internet, intranets, Virtual Private Networks, Wide Area Networks, Local Area Networks, and the like.

In the exemplary embodiment, the methods also include rules for “nonqualified” loan securitization pools. A non-qualified loan securitization pool is established by the program manager when a lender or multiple lenders have agreed to issue loans that do not meet the loan eligibility requirements for allocation to a loan securitization pool that can be securitized. Although the invention contemplates and includes such loans, it is to be understood that non-qualified securitization pools include loans that a lender must carry on its books until maturity, and that cannot be securitized through the securitization program offered by the security manager.

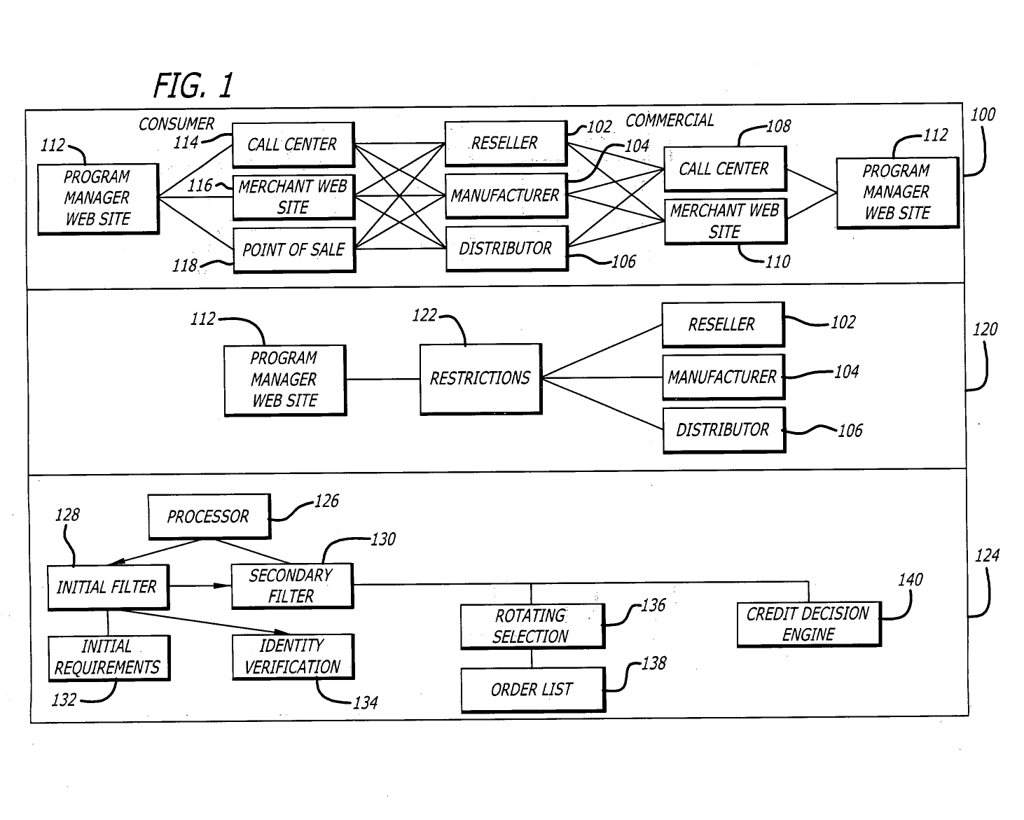

In accordance with the invention, loan eligibility requirements are implemented in layers that are progressively specific in their requirements. As illustrated in FIG. 1, the first layer 100 is the identity and security screen. Layer 100 begins with the establishment of participation rules for the participating credit applicants. Although this is referred to as a single layer, it may involve multiple business process rules that can include regulations established by the merchant, the merchant's customer, the lender, and the program manager. The systems and methods of the present invention are able to accommodate both commercial and consumer credit applicants.

Commercial credit applications are typically accessed through a particular reseller 102, manufacturer 104 or a distributor 106. The reseller 102, manufacturer 104 or distributor 106 use the online credit application method of the invention for its dealers or franchisees to obtain commercial loans. This could be done either through a telephone call center 108 or through a website 110 run by the reseller 102, manufacturer 104 or distributor 106.

In the case of a telephone call center 108, a call center representative would connect to a website of the program manager where a credit application would be provided. In the case where the website 110 of the reseller 102, manufacturer 103 or distributor 106 is the point of entry to the systems of the invention, there is a connection to the website 112 of the program manager that provides a credit application.

Access to the online credit application process is usually associated with a web store operated by the reseller 102, manufacturer 104 or distributor 106. After a customer has selected the products that it wants to purchase, he is provided options on how the goods are to be purchased. If the customer selects an option to finance the purchase, then he is automatically redirected to the website 112 of the program manager, where the credit application is presented. The website 112 of the program manager can be transparent to the customer if the merchant so chooses. In that case, when the customer is redirected to the website of the program manager, all of the data that the merchant has collected in its web based store regarding the products to be financed, personal or business information about the customer, and price and terms of the financing applied for are communicated via the web to the program manager. This data is stored in a file associated with the customer and is used to pre-populate any data field on the credit application that would otherwise be redundant to the customer.

Security controls may also be utilized in connection with the systems and methods of the invention, to control access to the website 112 for the loan manager. These security controls may include the use of digital signatures, user name and passwords, or other security controls. The nature and number of security controls that are used relate to the requirements for securitization of a loan securitization pool. For example, the securitizing investment firm may require that all borrowers be identified in person by an agent of the merchant. In that case, the program manager could be configured to require that the merchant's agent have a digital signature that could be used to uniquely identify them. The merchant's agent might also be required to sign an oath online with their digital signature attesting to the identity of the credit applicant and stating what means they employed to determine such identity. Of course, any of a number of security controls such as this could be implemented in accordance with various embodiments of the invention, as will be recognized by those skilled in the art.

Because the identity of the reseller 102, manufacturer 104 or distributor 106 may impact the type of credit that is available, this information is used by various embodiments of the invention to determine which credit application is to be presented to the credit applicant. Also, because there are significant differences in the data that are collected for a commercial loan and a consumer loan, the credit applications utilized by various embodiments of the invention reflect those differences. Therefore, the program manager preferably supports dynamic web page interfaces.

If the credit applicant is a consumer, access to the credit application can be achieved at either a website 114 of the reseller, manufacturer or distributor, through a telephone call center 116, or at a point of sale 118. Website 114 access and the telephone call center 116 access are achieved in the same manner for the consumer loan process as for the commercial loan process described above. In either case, the types of security controls utilized for the commercial loans would also be applicable. The program manager is responsible for keeping a record of how contact is initiated with the customer, as well as of the identity of the reseller 102, manufacturer 104 or distributor's 106 agent. This information can be used as part of the reporting process to the lender or the reseller 102, manufacturer 104 or distributor 106. The type of credit application that is displayed to the customer is based upon a set of computer program rules related to the access point and to the identity of the reseller 102, manufacturer 104 or distributor 106. In the case of point of sale 118 access, customer access to the credit application could either be accomplished by the intervention of a person at the point of sale making contact with the website of the program manager, or through a kiosk located at the merchant's point of sale.

The second layer 120 of rules to be applied is the identity and security screens by the program manager are related to restrictions 122 on the loan application process according to various embodiments of the invention. In some instances, the reseller 102, manufacturer 104 or distributor 106 may want to be the exclusive initiator of the loan application process. The program manager can provide such controls through the online identity process. To further enhance the assurance of payment for goods or services, the reseller 102, manufacturer 104 or distributor 106 can also select to implement a split payment mechanism. The split payment mechanism can become a pre-requisite to the presentation of a credit application, and has several purposes. First, it can enable a merchant to purchase goods without using its funds. It can also be used to ensure payment to the reseller 102, manufacturer 104 or distributor 106, or it can be used to provide anonymity of the credit applicant.

For example, a distributor may have multiple resellers to whom it distributes goods. The distributor has certain incentive programs for a selected portion of those resellers, that does not extend to other resellers. In that case, the distributor could advise the program manager of the resellers it will permit to use the incentives. The distributor thereby establishes a restriction 122 within the program manager, instructing the program manager that the incentive program is not to be made available to the other resellers.

As another example, resellers may be protective of their customers, and desire to keep the identities of their customers anonymous to the distributor. However, if the distributor desires to extend an incentive program directly to the reseller's customers, without disclosing the incentive program to the reseller. The web based split payment method of the exemplary embodiment invention, employed by the program manager, allows the reseller to direct its incentives accordingly, while allowing the resellers to protect their customer lists.

In an exemplary embodiment of the split payment mechanism, it is initiated by the reseller accessing the website of the distributor and determining the goods and services it wishes to purchase and their price and terms. The reseller can then request a split payment mechanism from the website of the distributor, which will connect the reseller to the program manager website. At the program manager website, the reseller is presented with a web based split payment form that the merchant completes by identifying the goods and services to be purchased and the price and terms that the distributor is charging for the goods and services. The split payment form also identifies the terms and conditions that the merchant is charging their customer for the identified goods, as well as the identity and email address or other information about the merchant's customer. The form then requests the reseller to complete an electronic signature authorization to pay the distributor a defined amount. An amount to be paid to the reseller is also defined. These data are used by the program manager if the loan is approved and funded for the distribution of loan proceeds.

The program manager captures these data into systems utilized by embodiments of the invention, which can then send an email to the reseller's customer with a user name and password together with a hyperlink to a credit application provided by the program manager. The URL embedded in the hyperlink and sent to the reseller's customer contains an address to a specific computer file that has used the information from the split payment mechanism and has pre-populated the credit application with the loan applicant's name, the loan amount and the goods and services to be purchased and their terms.

Continuing with this exemplary split payment mechanism, if the loan is approved through the system in this embodiment of the invention provided by the program manager, then the reseller and distributor will be notified electronically that pending funds are awaiting their approval. The distributor can view a list of the products and services to be financed with the loan, and the amount of funds being allocated by the reseller for the purchase at the website of the program manager. The distributor can also then verify that the funds are sufficient, and either approve the split payment terms or modify them. If modified, the reseller is notified electronically of the modification and must either approve or decline the modification. If declined, the loan will not be funded until the conflict has been resolved. If approved, at the time of funding the distributor will be sent to the designated funds upon verification having first been received that the distributor has provided the goods and services to the reseller or the customer of the reseller. The reseller will also be sent those funds attributable to the reseller's portion of the loan proceeds.

Of course, many levels of rules can be built into the identity and security screening process to facilitate program initiatives of both lenders and merchants. Various embodiments of the invention may therefore incorporate multiple modifications to the identity and security screening process. However, in accordance with the invention, these modifications are implemented with rules that do not violate existing rules established for a loan securitization pool. Of course, the rules cannot violate existing rules established for a non-qualified loan securitization pool either. However, it is anticipated as being within the scope of the invention for a set of rules to be established that could take an otherwise unqualified loan for a loan securitization pool and, by applying the rules set regarding, for example, a distribution of payments, make the loan a qualified loan.

Regardless of how a credit applicant obtains a credit application, once the credit application is accessed, a third layer of rules 124 is provided by the program manager. This third credit application rules layer 124 is employed by a computer processor 126 to determine whether the loan is eligible for inclusion in any of the loan securitization pools or non-qualified loan securitization pools. This includes, but is not limited to, determining whether the loan amount is sufficient to meet the loan eligibility requirement criteria, the jurisdiction of the applicant is compatible with a lender's charter, licenses and permits, the electronic identity score of the applicant meets the program standards, the loan applicant meets the credit criteria standards of the loan package, the loan is for a product approved for inclusion in the loan securitization pool, the loan has a term that matches the minimum requirements of the loan securitization pool, or if the merchant or manufacturer is an approved merchant of the loan securitization pool. It will be readily apparent to those skilled in the art how to program the program manager to implement such rules for determining the eligibility of a loan for a loan securitization pool and allowing only qualified loans to be allocated to the loan securitization pool.

In accordance with the invention, rules implemented by various embodiments of the invention are designed to ensure that a loan will always be assigned to a loan securitization pool if eligible, even though the loan may also qualify for a non-qualified loan securitization pool The credit application rules process 124 is divided into two sequential process: the initial filter process 128 and the secondary filter process 130.

During the initial filter process 128, a software filter analyzes data based upon the information included on the application and from other databases without utilizing a credit bureau report. As is well known in the art, credit bureau reports are provided by credit reporting agencies, and can be generated for either businesses or individuals. Numerous federal and state statutes, rules and regulations regarding the use of such reports must be followed when they are used. The initial filter process 128 takes place over the web in a real time mode, such that upon data being entered into a data field in the credit application, the data are captured by the program manager. Once data are so captured, rules are applied to the data.

Collected data are saved in a computer file that is dedicated to the applicant. The initial filter 128 is to determine, at block 132, whether the applicant can meet the minimum requirements for any of the offered programs by any of the participating lenders. This screen, when presented to the customer, could include data fields related to factors such as the age of the applicant, the residence or nationality of the applicant, the acceptability of the products or services to available lenders, and the like. The initial filter 128 also performs a preliminary identity fraud screening 134. Information obtained from the credit application can be compared to data that are stored in databases of third parties such as a social security database, drivers license databases, phone number and address databases, and the like. The program manager can compare the data to ensure that it matches the data stored in the third party databases. At the conclusion of the initial filter process 128, applications that pass are submitted to a secondary filter process 130.

The secondary filter process 130 is designed to operate under system rules that provide for assignment of a credit application to a specific lender. The rotating lender selection method 136, in an exemplary embodiment invention, allows each lender subscribing to a loan securitization pool to which a loan application has been allocated to be assigned the credit application. Specifically, the selection of a lender is based upon a “round robin” process. The process involves formulating an ordered list 138 of all subscribing lenders, ranging from the lender who was least recently assigned a credit application to the lender who was most recently assigned a credit application. Once the lender in the first position on the ordered list 138 has received and accepted a credit applicant, that lender rotates to the bottom position on the list. The ordered list 138 of lenders that is used for the rotating selection process 136 is also determined according to a set of rules created by the program manager. The program manager can qualify lenders for participation in various loan securitization pools. The program manager can also qualify lenders for non-qualified loan securitization pools. The rules are applied as the credit application is being completed by a customer.

After the credit application has been completed, the program rules determine for which loan securitization pools the credit applicant is eligible. Based upon rules, there will be a preference as to which qualified loan securitization pool will be selected, should the credit applicant be eligible for multiple loan securitization pools. Once the specific loan securitization pool has been selected by the rules, then all subscribing lenders to the loan securitization pool will be placed into the ordered list 138.

The lender selection process includes selecting a single lender from a list of multiple lenders based upon a rotating approach to allow a single lender to present a credit offer to the applicant. The program initially looks at the ordered list 138 and determines which lender is next in line to receive a loan or credit application. Upon determining the selected lender, the secondary filter 130 continues by determining the credit worthiness of the applicant

Each loan securitization pool has a set of loan eligibility requirements related to the credit worthiness of credit applicants. These rules utilize data supplied by a credit reporting agency as well as data supplied by the credit application in their functionality to determine the applicant's credit worthiness. This process is performed by a credit decision engine 140 within secondary filter 130. Credit decision engine 140 is a software program that retrieves data from a credit report and from a credit application, and analyzes these data based upon the pre-defined set of rules. Each credit reporting agency provides different data, so credit decision engine 140 must be programmed to support all possible data types. An exemplary method for providing such flexibility in credit decision engine 140 is to allow the credit decision engine 140 to determine which credit agency to request a report from, and which report type of the agency to use.

After the correct agency report is identified, the rules of the credit decision engine 140 determine which data from the credit agency report and the credit application are to be utilized for purposes of determining credit worthiness of the applicant. As will be recognized by those skilled in the art, numerous methods may be employed to generate such a decision. The rules are implemented sequentially according to their arrangements within the credit decision engine 140 as multiple tiers.

The program manager is also programmed to follow federal and state lending legislation, rules and procedures when generating credit decision rules. Also, when selecting a subscribing lender to whom a loan application will be offered for review, separate rotating decision processes may be utilized for loan securitization pools and non-qualified loan securitization pools. The program manager will also follow contractual guidelines for a lender in determining the volume of loans the lender is willing to accept.

The credit decision engine process employed by 140 preferably takes less than 100 seconds to generate a firm credit offer to an online applicant. Those skilled in the art will readily recognize that the rules and processes described herein may be performed by a software program capable of being executed in that amount of time.

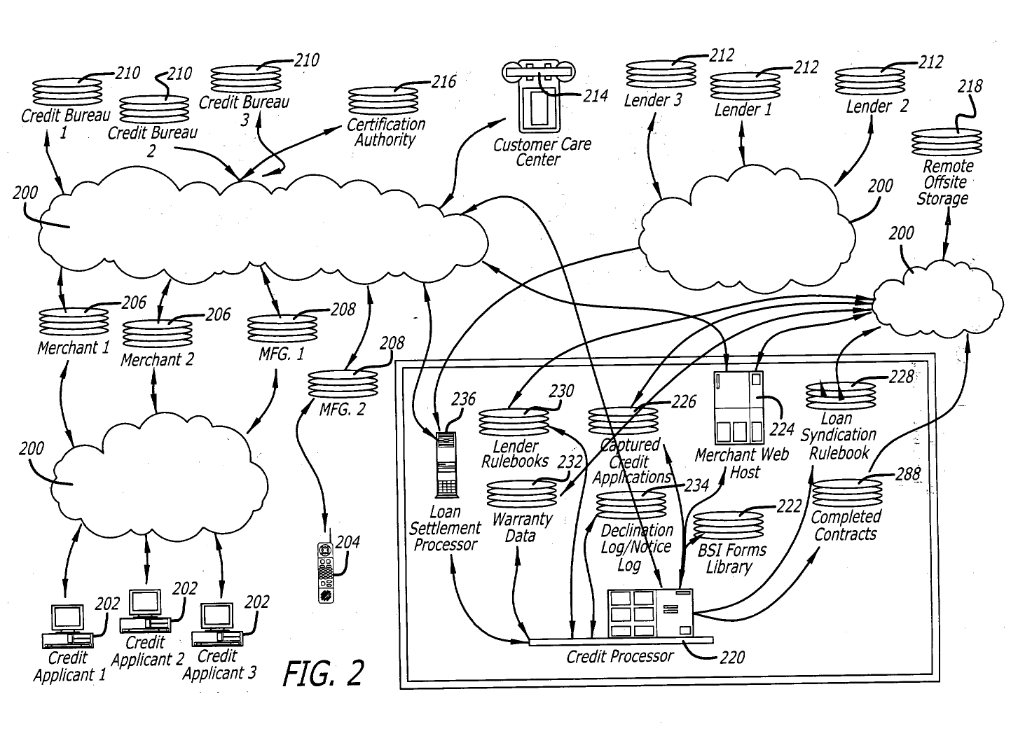

FIG. 2 illustrates a network relationship between credit applicants, merchants, lenders, credit bureaus and other entities involved in the systems and methods employed by embodiments of the invention. As described above, the web 200 is the primary communication medium between the various parties that participate in the systems and methods. These parties include credit applicants accessing systems employed by embodiments of the invention via computer 202 and credit applicants accessing systems of the invention via other remote devices such as mobile forms 204. Other parties include merchants 206, manufacturers 208, credit bureaus 210, lenders 212, customer care centers 214, certification authorities 216 and remote offsite storage providers 218. Systems employed by exemplary embodiments of the invention utilize a credit processors 220 to generate credit decisions for applicants utilizing methods employed by the various embodiments of the invention as described above. Credit processor thereby utilizes contract forms libraries 222 for generating loan contracts to provide to applicants, merchant web hosts 224 for receiving information on credit applicants and the products they are financing, data storage units 226 for retrieving captured credit applications provided by the applicants, loan syndication rule books 228 and lender rule books 230 for determining which, from among a plurality of available loans an applicant may be offered, and warranty data 232. Upon generation of a credit decision, the decision is generated to the applicant 202 and 204 via the Internet 202, and recorded in a notice log 234. If the applicant is accepted, loan settlement processor 238 functions to settle the loan with the applicant, and data storage unit 288 is used to store completed contracts.

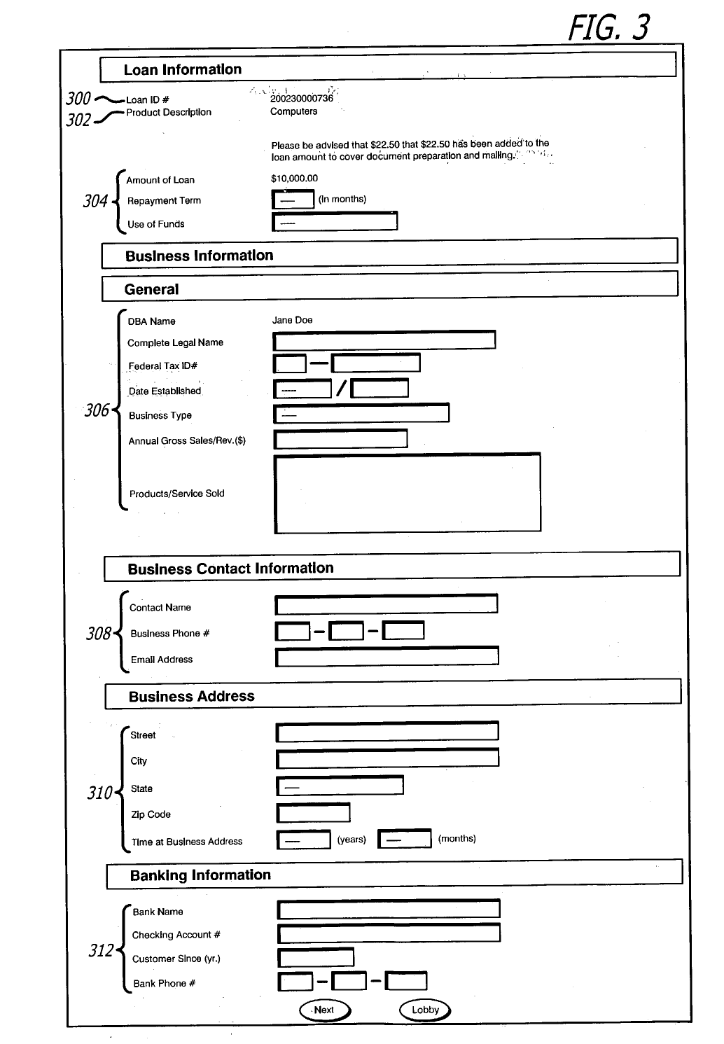

FIG. 3 illustrates a first exemplary computer input screen for receiving information from a credit application into a computerized system for performing methods in accordance with the invention. In the exemplary input screen, a loan identification number 300 is reported, with a product description 302 that informs the program manager of product description information for purposes of determining eligibility for an loan securitization pool as described above. Loan features 304 are also provided and may include, for example, the amount of the loan, the repayment term, and a category for the use of the funds. Business information 306 about the merchant is also reported, and the data requested therein is utilized in the credit decision process as described above. Additional merchant information includes business contact information 308 and business addresses 310. Finally, this computer screen requests banking information 312 of the merchant to whom the loan funds will be disbursed.

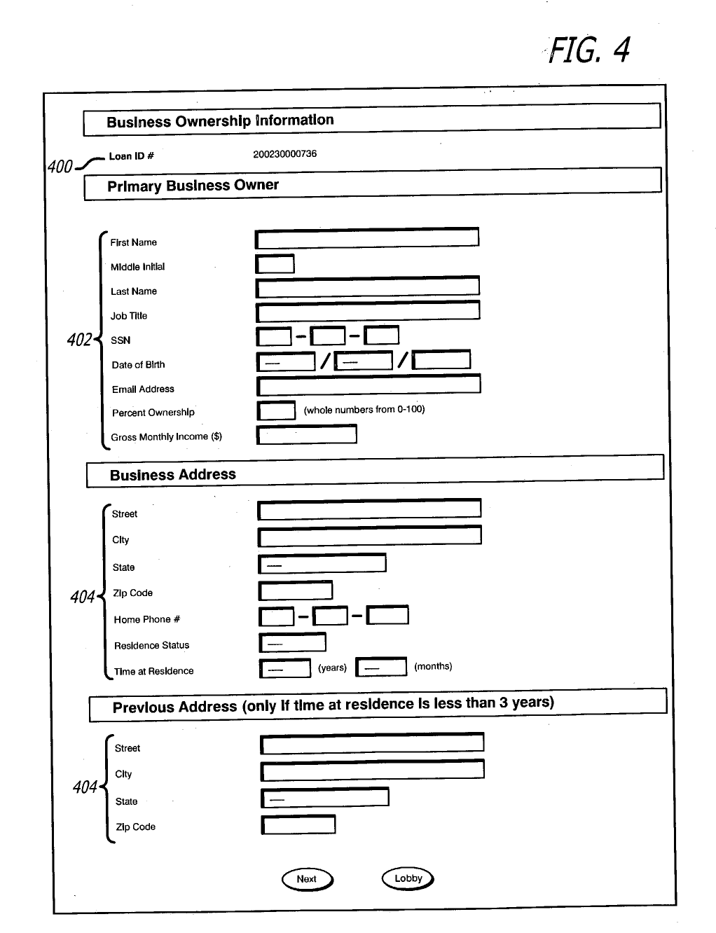

FIG. 4 illustrates a second exemplary computer input screen for receiving information from a credit application into a computerized system for performing methods in an embodiment of the invention. As in the previous exemplary computer input screen, the loan identification 400 is reported. In the case that the applicant is a business, information about the primary business owner 402 is requested, along with address information 404.

As part of the rules that may be included with a loan securitization pool, there may be the requirement that the credit applicant have a digital signature or complete some online identity process that can be insured for identity fraud protection. If this requirement is in place within a system or method utilized by an embodiment of the invention, then upon acceptance of the terms and conditions offered by the lender, the applicant's identity and credentials will be verified electronically and the integrity of the documents will be verified electronically. Such verification will provide the basis for a business process that will insure the identity of the signer and the integrity of the documents. Upon such verifications, the methods of this embodiment of the invention will operate to combine the necessary documents such that the combined documents constitute a negotiable instrument under the traditional definitions established in the Uniform Commercial Code, as well as satisfy international standards for negotiability.

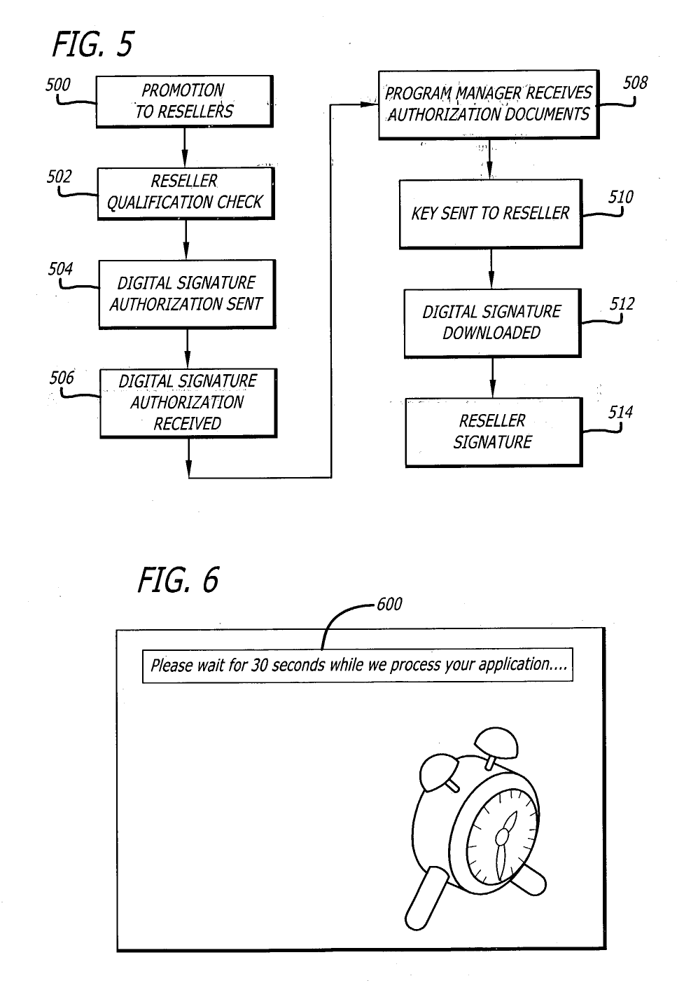

FIG. 5 illustrates an exemplary digital signature enrollment process that may be utilized with systems and methods utilized in an embodiment of the invention. As described above, at certain stages in the methods, digital signatures and digital verification may be utilized to complete lending processes. An exemplary process for establishing and providing such verification is illustrated in FIG. 5. First, at block 500, some exemplary methods may include promotion procedures for directing resellers to sales teams of distributors. Then, the distributor, at block 502, employs methods according to various embodiments of the invention including a credit decision engine to determine whether the reseller is qualified for an available loan program, provides an overview of the program to the reseller, and, in some cases, may forward an email to the reseller having program application documents attached. At block 504, the reseller completes a digital signature authorization document, has it notarized and returns the document along with an application fee, should it be required. At block 506, a certification authority receives the signed and notarized digital signature authorization document. Next, at block 508, the entity employing the program manager receives the notarized documents. The program manager acts to validate that the reseller was approved by the distributor, for example by determining whether an e-mail was received in block 502 as described above, for the reseller submitting the application. Next, in block 510, the program manager sends a universal serial bus (USB) key to the reseller along with an instruction manual. Then, in block 512, the reseller receives the USB key and downloads the digital signature onto the USB key. Finally, at block 514, the reseller uses the USB key, logs into the program manager website and is presented with a split invoice screen, as described above, after authentication. The USB key is then used to sign the completed application. Of course, it will be recognized by those skilled in the art that this is one exemplary authentication method, and that other well-known methods for digital authentication and verification may be readily employed with the systems and methods of various embodiments of the invention, and are considered to be within the scope of the invention.

FIG. 6 illustrates an exemplary computer information screen indicating to a credit applicant that a credit application is being processed in an embodiment of the invention. Although the exemplary screen indicates at 600 that the application will be processed in 30 seconds, this amount of time will vary from system to system. As described above, the processing time is preferably less than 100 seconds.

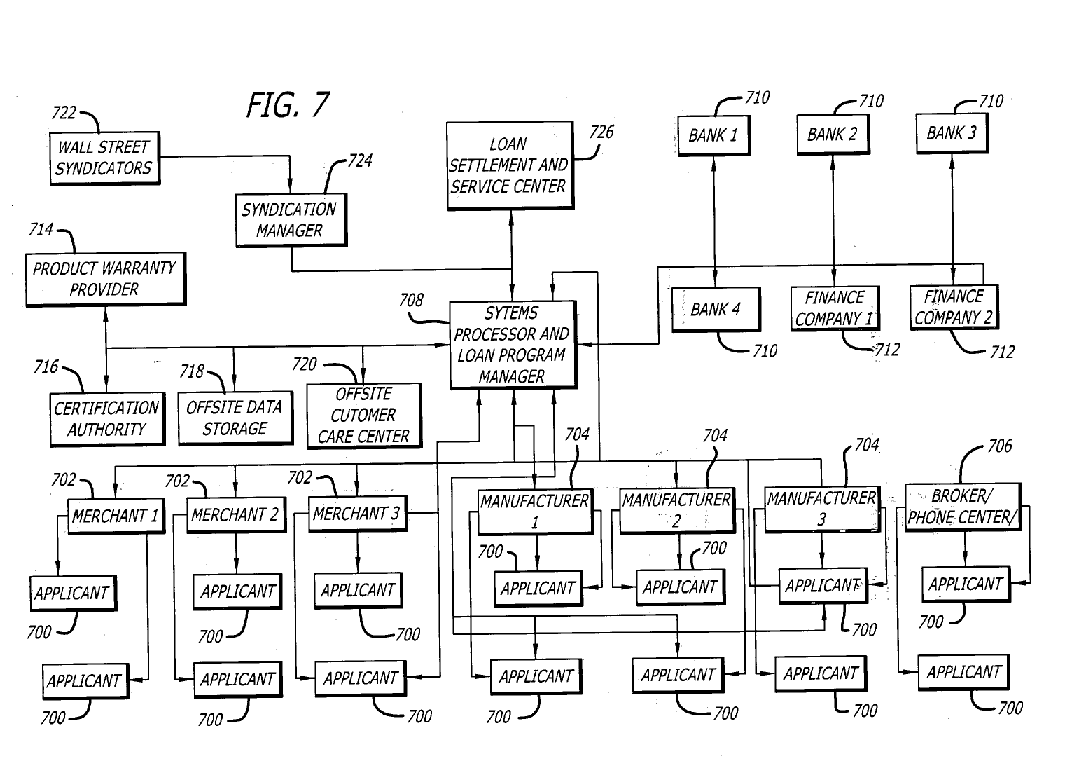

FIG. 7 illustrates a communication system diagram describing communications relationships between lenders, merchants, applicants and other entities involved in the systems and methods employed by various embodiments of the invention. Applicants 700 interact with merchants 702 and manufacturers 704, as well as with distributors, as described above. Entry points into the systems and methods may include a broker or phone center 706, or a website or point of sale interface, as described above. A systems processor and loan program manager 708 provides the main functionality of systems and methods, as described herein. Through the systems processor and loan program manager 708, the various participating entities interface with one another, and credit decisions are generated and processed. In addition to applicants, merchants and manufacturers, such entities include banks 710, finance companies 712 and other lending sources. The credit decision engine described above communicates with such entities as a product warranty provider 714, a certification authority 716, an offsite data storage provider 718 and an offsite customer care center 720, among others. Upon approval, the methods employed by exemplary embodiments of the invention may employ Wall Street syndicators 722 and a software syndication manager 724 to finalize the loan. Finally, loan settlement and service center 726 is employed to make the final loan offer to the approved applicant.

In addition to the functionality of various aspects of the invention described above, exemplary methods allow for the credit applicant to review the proposed loan documents online after the application has been accepted. An acceptance notification may be communicated to the applicant via a computer notification screen, as illustrated in FIG. 8 at 800. Terms of the offered loan are also reported to the applicant, at 802. These terms may be accepted at box 804 or rejected at box 806.

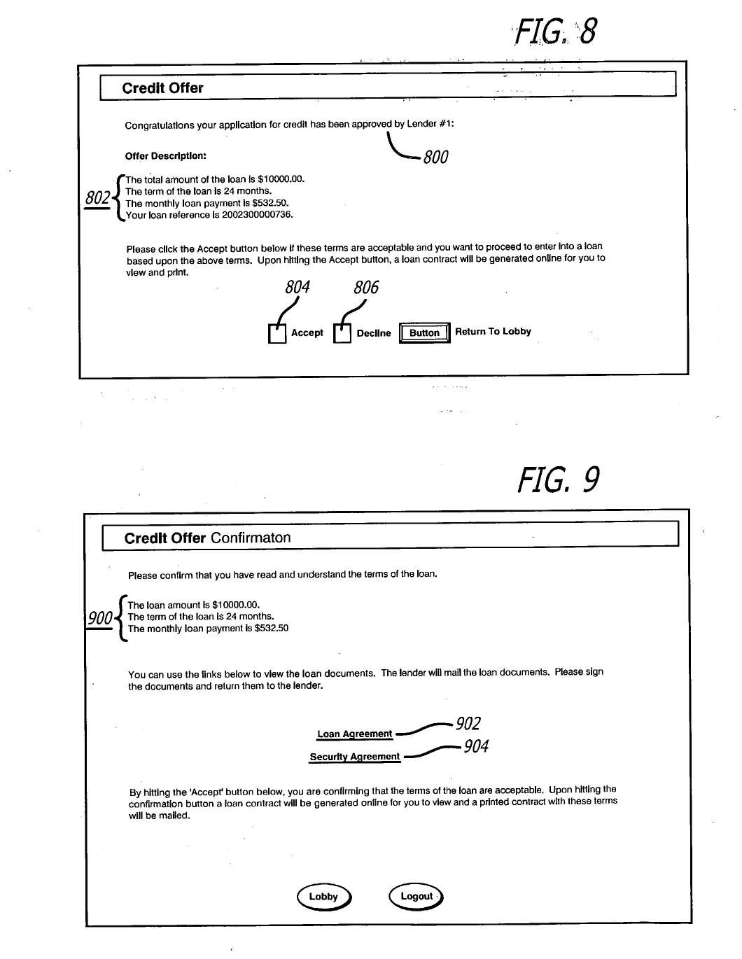

As illustrated in FIG. 9, The applicant can then review the details of the loan agreement, by clicking on a link 902 to the details. The applicant may also review a security agreement 904, or other loan agreements that are provided by systems and methods in accordance with the invention. Once the credit applicant has reviewed the documents, they may approve or decline them either online by employing an electronic signature, or on paper by downloading and printing forms that are then signed and forwarded by mail.

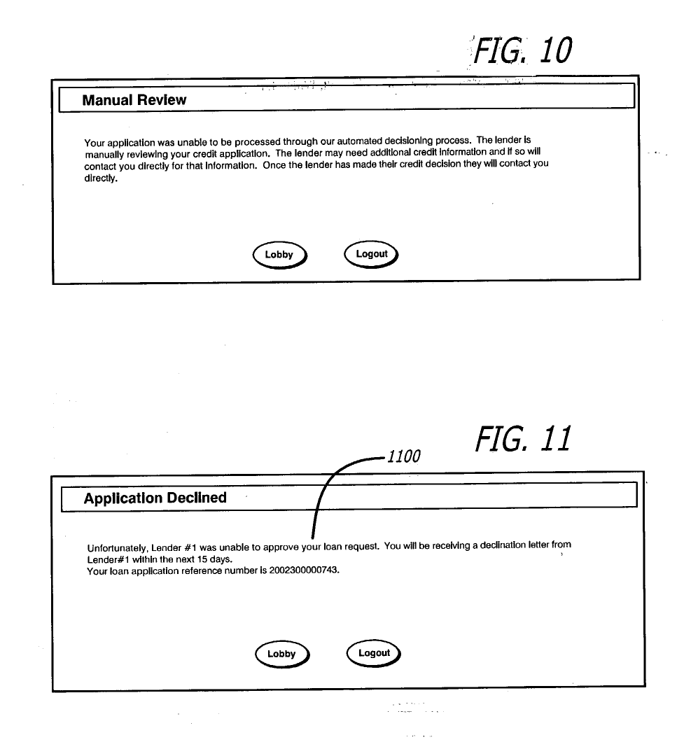

In the event that a credit application is declined for both the loan securitization pools and the non-qualified loan securitization pools, the credit applicant is notified online of the decline notification. As illustrated in FIG. 10, the applicant may be advised that either their credit application will be manually reviewed by lenders in the program, or, if the credit application does not meet any of the minimum criteria for any of the manual non-qualified loan securitization pools, the applicant will be provided an online declination notice as illustrated in FIG. 11 at note 1100, and a written notice if required by federal or state legislation, rules and regulations.

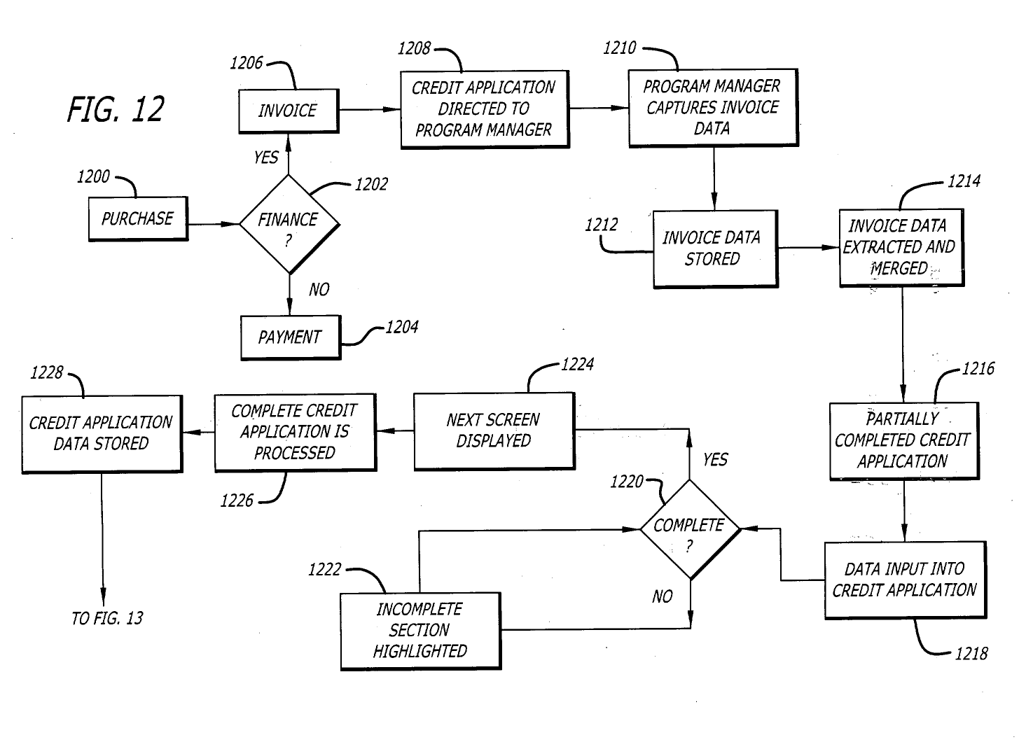

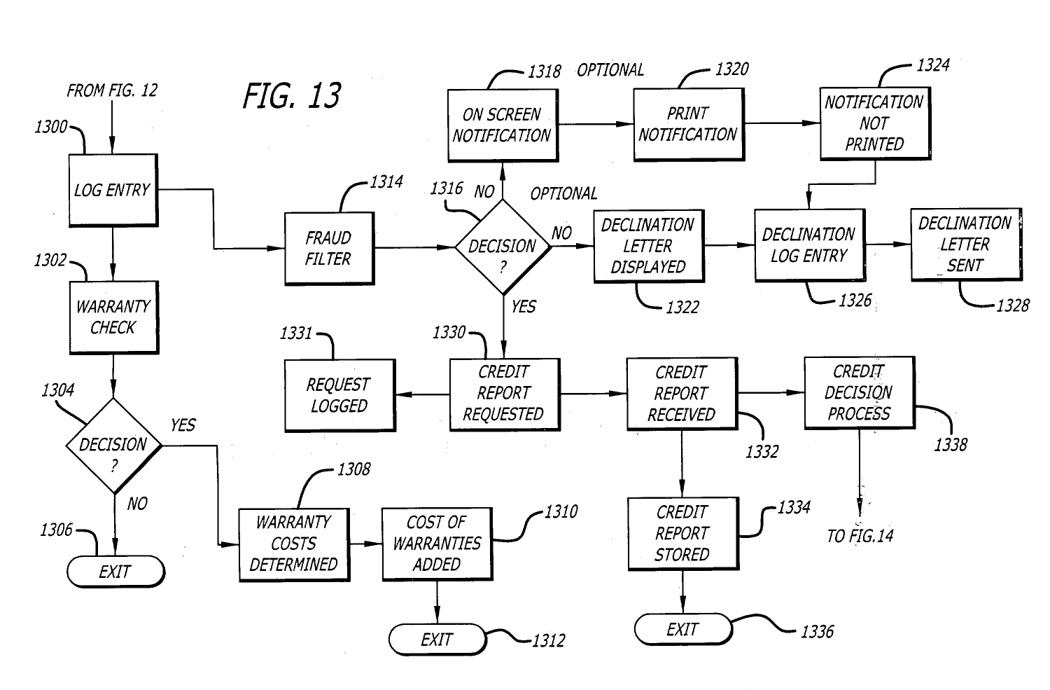

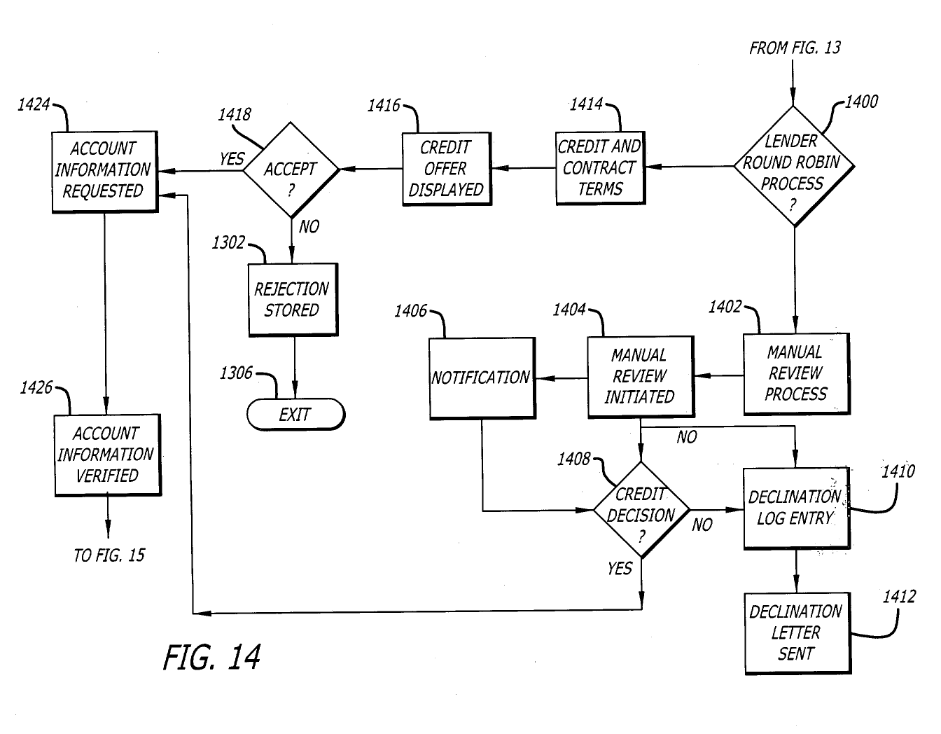

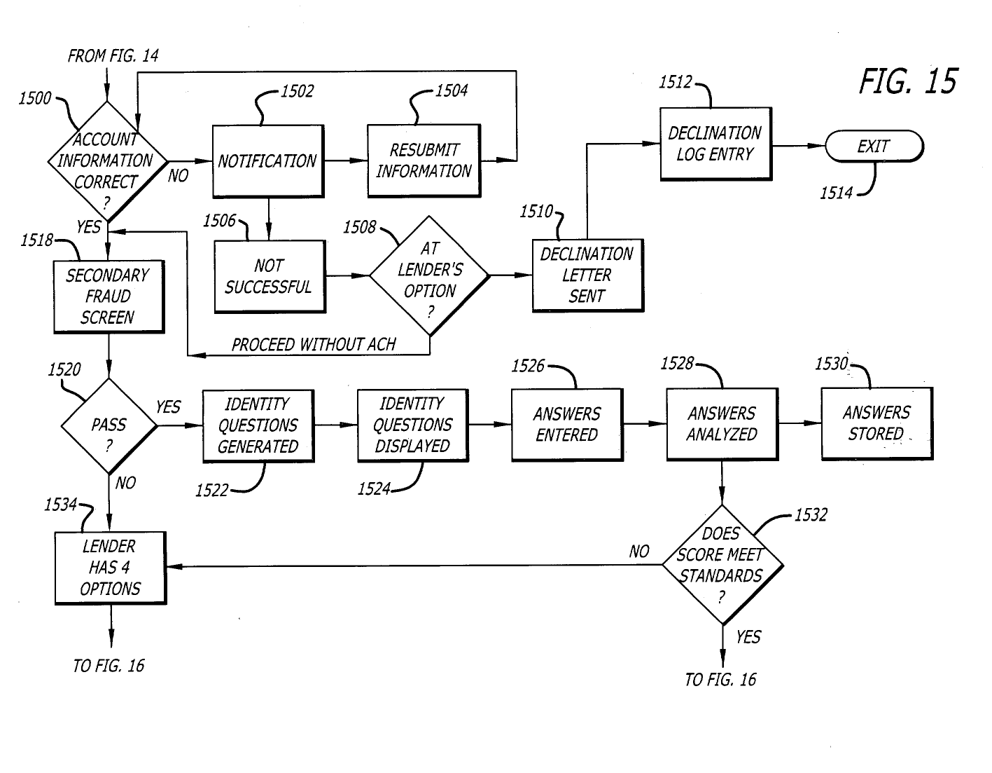

FIGS. 12-17 illustrate an exemplary system in an embodiment of the invention as applied in an online merchant environment. The steps illustrated in FIGS. 12-17 are an exemplary combination of steps for performing the processes described above. At block 1200, a customer visits a merchant or manufacturer website and selects an item for purchase by placing it in his online shopping cart. At decision block 1202, the consumer decides whether or not to finance the purchase. If no, then the consumer either pays with an existing credit card, mails a check, uses a debit card, electronic check or abandons the purchase, as indicated at block 1204. Otherwise, the website captures the shopping cart invoice as indicated at block 1206. At block 1208, the applicant is redirected to the merchant's credit site, hosted at the program manager website. Then, at block 1210, the program manager captures the invoice data, which is then stored in a credit application database and assigned to a unique customer identifier, at block 1212. At block 1214, invoice data is extracted and merged with a blank program manager generic credit application form. At block 1216, the applicant is presented with a partially completed credit application that the program manager populated with invoice data, and lenders participating in a loan securitization pool are disclosed to the applicant. At block 1218, the customer inputs data into the credit application, through fields on a web hosted application or form. At block 1220, the program manager verifies each customer-submitted screen of application input data for completeness. Where areas are incomplete, they are highlighted and re-presented to the customer for completion as indicated at block 1222. Once complete, the next credit application screen is displayed as indicated at block 1224, and this process continues until the completed credit application is processed and the data field information is extracted and analyzed by the program manager, at block 1226. At block 1228, the credit application data is stored in completed application database storage under the previously assigned unique customer identification number.

At block 1300, an entry is made in a completed application log, and then at block 1302, the credit application is analyzed to determine which of the customer selected products being financed have warranties. A warranty decision is generated at block 1304. If no warranties are available, no further warranty action is required, as indicated at block 1306. Otherwise, warranty costs are pulled from the warranty database to match the product identification numbers, as indicated at block 1308. Then, at block 1310, the cost of warranties are added to invoice data in the credit application database to be displayed as an option at the time that a credit offer is displayed, should the application ultimately be approved. At that point, as indicated at block 1312, no further warranty action is required.

At block 1314, the program manager captures and analyzes the credit application information, and runs the initial filter process, including fraud and identity filters, as described above. An initial filter decision is made at block 1316. If the applicant fails the initial filter process as indicated at block 1318, the applicant may be notified on screen of his inability to qualify for credit. The applicant may then be given an option to download and print the declination letter, at block 1320, and if the letter is not printed or downloaded, as indicated at block 1324, then an entry is made into a declination log at block 1326. Similarly, a lender specific declination letter may be displayed on screen for the applicant at block 1322, and an entry made into the declination log at block 1326. In either case, the declination letter is printed and mailed to the applicant at block 1328.

If, on the other hand, the applicant passes the initial filter process, then a credit bureau report is requested, based upon the jurisdiction of the applicant, as indicated at block 1330. At block 1332, the report is received and analyzed, and the credit decision engine processes a decision at block 1338. Also, the report is stored in a database under the unique customer identification number, at block 1334. In that case, no further action is required, as indicated at block 1336.

In the case that the credit decision engine is processing a decision, however, the next step employed by systems and methods in accordance with the invention is for a lender to be selected according to a rotating decision process, indicated at block 1400. If no lender will accept the application for automatic approval, then, at block 1402, the application is sent to the first lender in the ordered list, compiled as described above, for a manual review process. The manual review is initiated at block 1404, and a message is displayed at block 1406 that the credit application is under manual review, and advising the applicant to remain online for an impeding decision. A decision is generated at block 1408. If the decision is negative, the customer is added to the declination log at block 1410, and a declination letter is printed and mailed at block 1412. If, however, the decision is affirmative, credit terms for the approved loan are considered at block 1424. Similarly, if a lender does accept an application under its automatic review process in the rotating selection method at block 1400, the credit terms and type of contract are determined to include warranty options, if appropriate, at block 1414. Next, at block 1416, a credit offer in abbreviated form is displayed on the screen for the applicant to review, along with warranty options. A decision to accept or reject the credit offer is made by the applicant at block 1418. If the applicant rejects, the rejection is stored in an application log database at block 1420, and no further action is required, as indicated at block 1422. Otherwise, the process returns to block 1424, in which account information is requested form the applicant if the credit terms include automatic withdrawal from the applicant's personal banking account. Then, at block 1426, the personal account information is verified.

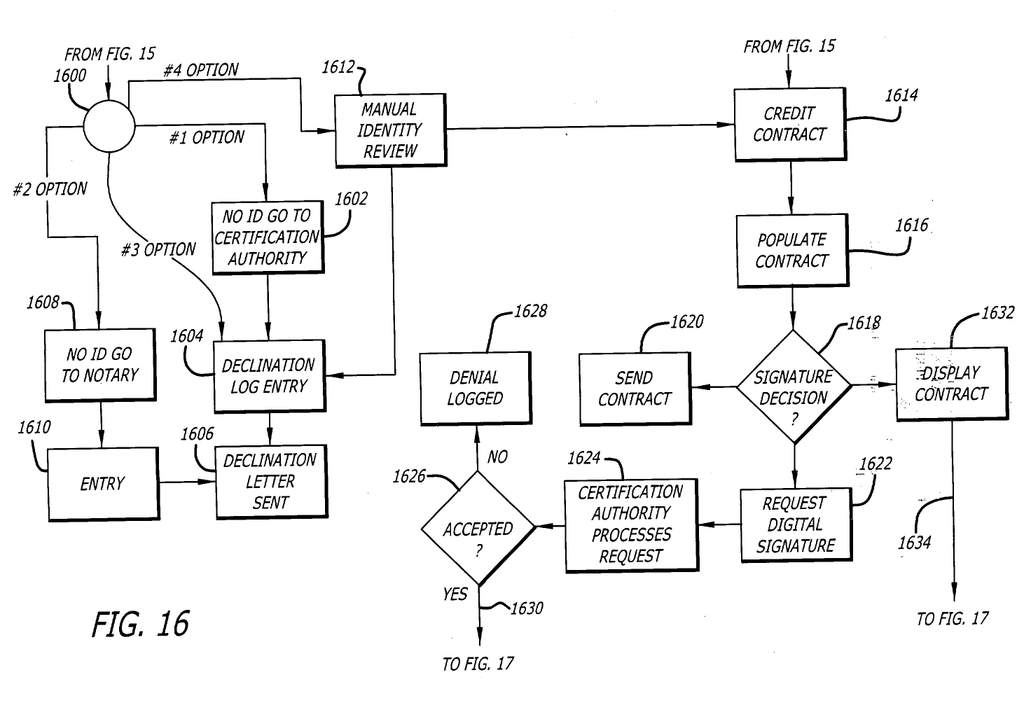

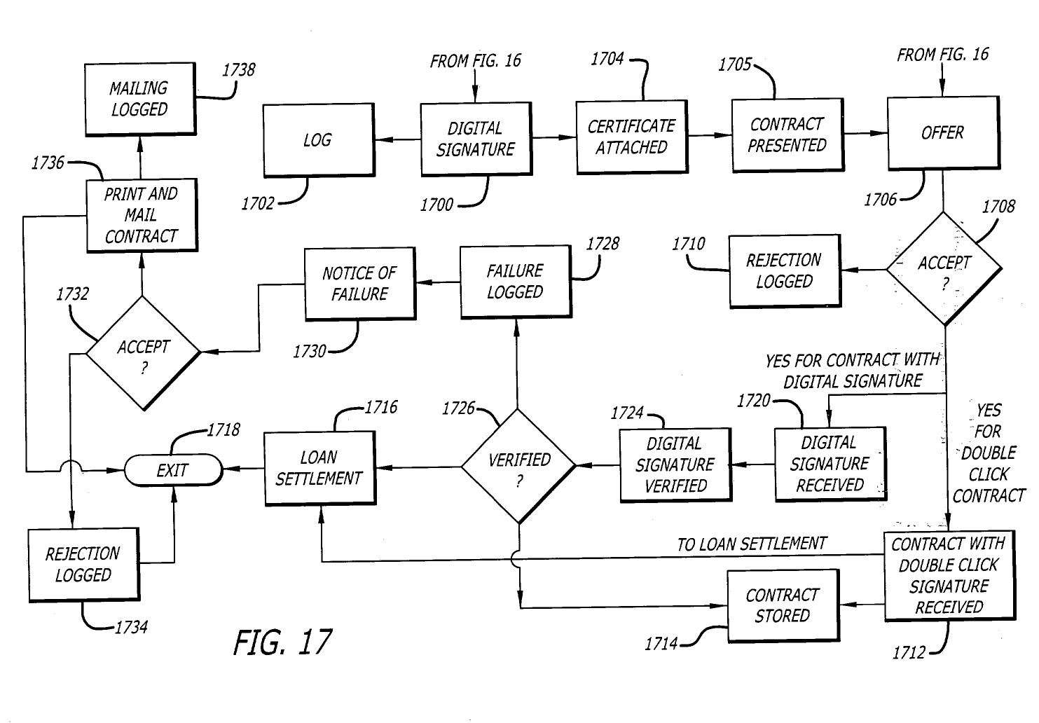

Continuing with FIG. 15, the program manager determines whether the personal account information is correct at block 1500. If no, then the applicant is notified at block 1502 that the information is not confirmed, and is requested to check and resubmit the information. The customer resubmits the information at block 1504, and the verification procedure is repeated. If the verification is not successful on the second attempt, at block 1506, then the lender has the option, at block 1508, to decline immediately or proceed. If the lender chooses to decline, a declination letter is printed and mailed to the applicant at block 1510, the declination is added to the log at block 1512, and no further action is required, as indicated at block 1514. Otherwise, if the lender chooses to proceed without verifying the customer's personal account information, as indicated at arrow 1516, the process continues with an affirmative response to the decision made at block 1500. A second identity fraud screen is then run at block 1518, and a determination is made at block 1520. If the applicant passes the second identity fraud screen, identity questions are generated at block 1522, and are displayed to the applicant at block 1524. The credit applicant enters answers at block 1526, and the program managers analyzes and scores the answers at block 1528. It is then considered, at block 1532, whether the identity score generated at block 1528, meets standards employed by the program manager. If no, the lender has multiple options, as indicated at block 1534 and described in FIG. 16. Otherwise, the lender follows a different path, also described with reference to FIG. 16.

At block 1600, the lender faces four distinct options. At block 1602, the loan applicant can be given notice that an identification cannot be established and that the application is unable to proceed. The applicant is then presented with instructions for activating a hyperlink to a certification authority to generate or establish a valid identification. The customer is added to the declination log, with a notation that the reason for declination was that an identification could not be established. A declination letter is also printed and mailed, as indicated at block 1606. The second option for the lender is to give the applicant notice, at block 1608, of the inability to establish an identification, and to give the applicant the ability to download and print the application with identity confirmation to be provided by a notary and mailed to a processing center. The customer is still added to the declination log, with a notation that an identification could not be generated, as indicated at block 1610, and a declination letter is printed and mailed at block 1606. The third option for the lender is to automatically add the customer to the declination log with a notation that an identification number could not be established, at block 1604, and print and mail a declination letter at block 1606. Finally, the lender has the option of sending the application for manual review, at block 1612. In this case, the process proceeds to block 1614, which is the same point in the process that picks up from block 1532 of FIG. 15.

At block 1614, credit contract forms are pulled from a forms library, with consideration given to the applicant's jurisdiction. Then, at block 1616, a contract is populated with data retrieved by the program manager from the customer application database. A signature decision is made at block 1618. As a result of this decision, the lender may require a wet signature at block 1620, in which case the contract must be printed, signed, and mailed with return service. Or, the lender may send a request to a certification authority for a digital signature, at block 1622, and the certification authority would process the request at block 1624. If the request is denied, then a denial of the request is logged in the credit application with a notation of the reason for denial, at block 1628. Otherwise, if the request is granted, the process proceeds with steps illustrated in FIG. 17, as indicated at arrow 1630. Similarly, the lender may resolve the signature decision at block 1618 by presenting a contract to the applicant online, at block 1632, with a double click option to activate, in which case, as indicated at arrow 1634, the process proceeds with steps illustrated in FIG. 17.

In the event that the digital signature request is approved, a digital signature is generated by the certificate authority at block 1700, and an issuance with a customer identification number is logged at block 1702. Also, the certificate is attached to the loan contract at block 1704, and the contract with signature is presented to the applicant at block 1705. At this point, the process continues with the steps encountered in the scenario described above, where the customer is presented a contract with a double click option. At block 1706, the applicant accepts or declines the offered loan contract, making a decision at block 1708. If the applicant chooses to decline, a rejection of the offer is logged in the credit application database and rejection by customer is annotated. Otherwise, if the applicant accepts the double click version of the contract, the accepted contract with the double click signature is received by the program manager at block 1712, and the contract is stored with the verified signature in the completed contract database, and logged into the lender database with the customer identification number at block 1714. Similarly, if the contract is accepted with a digital signature, the accepted contract and digital signature are received at block 1720, and the digital signature is submitted for verification with a certification authority, at block 1724. If the signature can be verified at block 1726, then the contract is stored and logged at block 1714, and the contract is sent to loan settlement at block 1716 before the process is terminated at block 1718. Otherwise, if the digital signature verification failed, as indicated at block 1728, a customer care center associated with the program manager is sent notice of failure with directions to contact the customer and the certification authority to determine the cause of failure. The customer care center queries whether the customer wants a contract, at block 1732. If not, then at block 1734 the rejection is logged in the credit application database with an annotation about the rejection. Otherwise, at block 1736 the contract is printed and mailed to customer care, the mailing is logged in the credit application database at block 1738, and the process is terminated, at block 1718.

In addition to providing rules for establishing a loan securitization pool, the securitization manager must provide software for monitoring constituent loans of a loan securitization pool to determine whether the loans continue to meet the minimum requirements of the loan securitization pool prior to its securitization. For example, a loan initially having a first set of loan features such that it is qualified for the loan securitization pool to which it is allocated, may undergo a change in loan features. For example, the loan amount may decrease as its balance is repaid, or the borrower may fail to make payments and cause the loan to enter default. The securitization manager is programmed to detect such changes in loan features, identify the second, changed set of loan features, and determine whether they are in accordance with the loan eligibility requirements of the loan securitization pool to which the loan is allocated. If the securitization manager determines that the loan is no longer qualified for the loan securitization pool, it searches for a loan securitization pool for which the loan, with its new, second set of loan features, is still qualified. If a second loan securitization pool is identified, the loan is re-allocated to the second loan securitization pool. This functionality of the securitization manager prevents lenders from having to carry such loans on their books when they happen to fall out of the loan securitization pool to which they were originally allocated.

The securitization manager is also programmed to establish a process supported by verifiable standards that provides an electronic process for rating the negotiability of the loan securitization pool. The process would further provide a stated value for the loan securitization pool based upon the negotiability rating and the assigned warranties, if any. The process would further provide an electronic forum where identified and approved traders could buy, sell and trade an interest in the loan securitization pools. This process would be made available to any trade transaction based upon a rule book established by the securitization manager, and expands the range of opportunities for lenders to convert their loan portfolios to cash.

While the specification describes particular embodiments of the present invention, those of ordinary skill can devise variations of the present invention without departing from the inventive concept.

We claim:

1. A method of managing a loan securitization pool that has one or more loans, each with features that meet all loan eligibility requirements for that pool, comprising:
a) receiving information indicative of a change in the features of a loan in one of the pools;
b) determining whether the changed feature causes the loan to no longer meet all of the loan eligibility requirements for the pool to which it has been allocated; and, if so,
c) removing the loan from the pool to which it had been allocated.

2. The method of claim 1, further comprising re-allocating the removed loan to a different loan securitization pool if the changed loan features meet all loan eligibility requirements for the different pool.

3. A method of managing multiple loan securitization pools, comprising:
a) entering loan features for a loan into a computerized system;
b) querying a storage system to determine loan eligibility requirement factors for each of a plurality of loan securitization pools;
c) from the plurality of loan securitization pools, identifying a first loan securitization pool for which the loan is qualified based on the entered loan features and on the determined loan eligibility requirement factors for the first loan securitization pool;
d) allocating the loan to the first loan securitization pool; and
e) identifying a second loan securitization pool for which the loan is qualified based on the entered loan features and on the determined loan eligibility requirement factors for the second loan securitization pool.

4. The method of claim 3, further comprising re-allocating the loan to the second loan securitization pool.

5. The method of claim 3 wherein the loan eligibility requirement factors comprise a loan repayment term.

6. The method of claim 3 wherein the loan eligibility requirement factors comprise a loan interest rate.

7. The method of claim 3 wherein the loan eligibility requirement factors comprise a loan classification indicating a loan type of revolving credit.

8. The method of claim 3 wherein the loan eligibility requirement factors comprise a loan classification indicating an installment loan type of installment.

9. The method of claim 3 wherein the loan eligibility requirement factors comprise a loan securitization classification indicating the type of collateral that is secured by the loan.

10. A method of managing multiple loan securitization pools, comprising:
a) allocating a loan to a first loan securitization pool for which it is qualified based on an initial set of loan features and on loan eligibility requirement factors for the first loan securitization pool;
b) determining a second set of loan features if the loan becomes disqualified from the first loan securitization pool;
c) identifying a second loan securitization pool for which the loan is qualified based on the second set of loan features and on loan eligibility requirement factors for the second loan securitization pool; and
d) re-allocating the loan to the second loan securitization pool.

11. The method of claim 10 wherein the loan eligibility requirement factors comprise a loan repayment term.

12. The method of claim 10 wherein the loan eligibility requirement factors comprise a loan interest rate.

13. The method of claim 10 wherein the loan eligibility requirement factors comprise a loan classification indicating a loan type of revolving credit.

14. The method of claim 10 wherein the loan eligibility requirement factors comprise a loan classification indicating a loan type of installment.

15. The method of claim 10 wherein the loan eligibility requirement factors comprise a loan securitization classification indicating the type of collateral that is secured by the loan.

16. A system for managing multiple loan securitization pools, comprising:
a) an input device for entering loan features for a loan into a computerized system;
b) a storage system operatively connected to the input device and configured to store the entered loan features;
c) a processor operatively connected to the storage system and configured to determine loan eligibility requirement factors for each of a plurality of loan securitization pools;
d) the processor further configured to identify, from the plurality of loan securitization pools, a first loan securitization pool for which the loan is qualified based on the entered loan features and on the determined loan eligibility requirement factors for the first loan securitization pool;
e) the processor further configured to allocate the loan to the first loan securitization pool; and
f) the processor further configured to identify a second loan securitization pool for which the loan is qualified based on the entered loan features and on the determined loan eligibility requirement factors for the second loan securitization pool.

17. The system of claim 16, wherein the processor is further configured to re-allocate the loan to the second loan securitization pool.

18. The system of claim 16 wherein the loan eligibility requirement factors comprise at least one factor selected from the group consisting of: loan repayment term, loan interest rate, loan type of revolving credit, loan type of installment, and type of product financed by the loan.

19. A system for managing multiple loan securitization pools, comprising:
a) a processor for allocating a loan to a first loan securitization pool for which it is qualified based on an initial set of loan features and on loan eligibility requirement factors for the first loan securitization pool;
b) the processor further configured to determine a second set of loan features if the loan becomes disqualified from the first loan securitization pool;
c) a storage system for storing information about a plurality of loan securitization pools;
d) the processor further configured to query the storage system to determine loan eligibility requirement factors for a plurality of loan securitization pools;
e) the processor further configured to identify, from the plurality of loan securitization pools, a second loan securitization pool for which the loan is qualified based on the loan features and on loan eligibility requirement factors for the second loan securitization pool; and
f) the processor further configured to re-allocate the loan to the second loan securitization pool.

20. The system of claim 19 wherein the loan eligibility requirement factors comprise at least one factor selected from the group consisting of: loan repayment term, loan interest rate, loan type of revolving credit, loan type of installment, and type of product financed by the loan.

21. Computer-readable media containing instructions executable by a computer that, when loaded and executed on the computer, perform a method of managing multiple loan securitization pools, including:
a) receiving loan features for a loan into a computerized system;
b) querying a storage system to determine loan eligibility requirement factors for a plurality of loan securitization pools;
c) from the plurality of loan securitization pools, identifying a first loan securitization pool for which the loan is qualified based on the received loan features and on loan eligibility requirement factors for the first loan securitization pool;
d) allocating the loan to the first loan securitization pool; and
e) identifying a second loan securitization pool for which the loan is qualified based on the received loan features and on loan eligibility requirement factors for the second loan securitization pool.

22. The computer-readable media of claim 21 wherein the instructions, when loaded and executed on a computer, additionally cause the loan to be reallocated to the second loan securitization pool.

23. The computer-readable media of claim 22 wherein the loan eligibility requirement factors comprise at least one factor selected from the group consisting of: loan repayment term, loan interest rate, loan type of revolving credit, loan type of installment, and type of product financed by the loan.

24. Computer-readable media containing instructions executable by a computer that, when loaded and executed on the computer, perform a method of managing multiple loan securitization pools, including:
a) allocating a loan to a first loan securitization pool for which it is qualified based on an initial set of loan features and on loan eligibility requirement factors for the first loan securitization pool;
b) determining a second set of loan features if the loan becomes disqualified from the first loan securitization pool;
c) querying a storage system to identify a second loan securitization pool for which the loan is qualified based on the second set of loan features and on loan eligibility requirement factors for the second loan securitization pool; and
d) re-allocating the loan to the second loan securitization pool.

25. The computer-readable media of claim 24 wherein the loan eligibility requirement factors comprise at least one factor selected from the group consisting of: loan repayment term, loan interest rate, loan type of revolving credit, loan type of installment, and type of product financed by the loan.
